(19) United States
(12) Patent Application Publication
(10) Pub. No.: US 2011/0082727 A1
(43) Pub. Date: Apr. 7, 2011

(54) SYSTEM AND METHODS FOR ADVERTISING

(76) Inventor: Ricardo Macias, Round Lake Beach, IL (US)

(21) Appl. No.: 12/897,752

(22) Filed: Oct. 4, 2010

Related U.S. Application Data
(60) Provisional application No. 61/248,850, filed on Oct. 5, 2009.

(51) Int. Cl. G06Q 30/00

(52) U.S. Cl. 705/14.4

(57) ABSTRACT

Methods and systems of advertising on the notification windows of any incoming/outgoing SMS/MMS and contributing the corresponding advertising dollars to the monthly bill of cell phone users, who are using the underlying software application, are provided. The direct dollar contribution by the advertiser to the cell phone users' monthly bill decreases the monthly amount the users owe the mobile phone service provider. Hence, the users' cost of using a cell phone decreases considerably.

### CROSS-REFERENCE TO RELATED APPLICATIONS

This application claims the benefit of U.S. Provisional Application No. 61/248,850, filed Oct. 5, 2009, which is hereby incorporated by reference.

### BACKGROUND OF THE INVENTION

1. Field of the Invention

The present invention relates generally to advertising systems and methods and particularly to advertising on mobile devices such as cell phones, smart phones and the like.

2. Description of the Related Art

Cell phone advertising is not compensating the cell phone user to the extent that it should, such as the possibility of offering free cell phone usage through the use of particular ad-supported applications. Cell phone applications (“apps”) limit the amount of compensation users receive to offering only free or low-cost apps.

Furthermore, native applications and/or software that can be updated, and/or with which, an application designed to run this type of mobile marketing may be easily integrated, are available. However, the existing native applications and/or software are not being utilized to the extent that they could.

Moreover, overall, cell phone bills have not gotten cheaper. Advertisers are contributing millions of dollars to the wireless industry, but these monies are not being offered, in any way, as personal rewards or benefits to the cell phone user.

The problems and the associated solutions presented in this section could be or could have been pursued, but they are not necessarily approaches that have been previously conceived or pursued. Therefore, unless otherwise indicated, it should not be assumed that any of the approaches presented in this section qualify as prior art merely by virtue of their presence in this section of the application.

### BRIEF SUMMARY OF THE INVENTION

The present invention solves the problems enumerated above by offering methods and systems of advertising on the notification windows of any incoming/outgoing SMS/MMS and contributing the corresponding advertising dollars to the monthly bill of cell phone users who are using the underlying software application. The direct dollar contributions by the advertisers to the cell phone users' monthly bill decrease the monthly amount the users owe the mobile phone service provider. Hence, the users' cost of using a cell phone decreases considerably. Alternatively, the contributions may be sent directly to the users. This is particularly of great value to the users in a struggling economy as the one we are currently experiencing.

Furthermore, a novel and non-intrusive ad placement and interactivity is hereby provided, as it will be explained in detail below.

This method streamlines the process so that carriers, handset manufacturers, and OS (operating system) developers can offer cell phones with built-in programs that offer cell phone users the opportunity to lower their cell phone bills as soon as they buy a particular handset.

Mobile advertisers can use this method to spend their advertising dollars in a more effective manner since most of the advertising dollars they spend using this method will be sent to lower the mobile device (e.g., cell phone) user's bill. Hence, a “special” relationship is created between the advertisers and their audience (i.e., the mobile device users), and therefore, a better impression on audience's mind is likely to be produced. Furthermore, this method may potentially offer a very efficient way for the advertisers to spend their marketing funds. This is because, when they pay the fixed cost of, for example, the user's unlimited messaging service, they have the chance of displaying their ads to the user an unlimited number of times. Thus, this is potentially more advantageous than a limited number of times, once a specified budget is reached, as it is the case with in a Cost-per-click (CPC) or Cost-per-impression (CPI), or other methods known in the art.

### BRIEF DESCRIPTION OF THE DRAWINGS

For exemplification purposes, and not for limitation purposes, embodiments of the invention are illustrated in the figures of the accompanying drawings, in which:

FIG. 1a is a flow chart depicting an overview of an exemplary method and system of cell phone advertising according to this invention (continued in FIG. 1b).

FIG. 1b is a continuation of FIG. 1a.

FIG. 2a is a flow chart outlining an exemplary process of cell phone advertising, when a user sends a message, according to this invention.

FIG. 2b is a flow chart outlining an exemplary process of cell phone advertising, when a user receives a message, according to this invention.

FIG. 3 depicts exemplary mobile device screens with exemplary messages according to this invention.

### DETAILED DESCRIPTION OF THE INVENTION

What follows is a detailed description of specific embodiments of the invention in which the invention may be practiced. Reference will be made to the attached drawings, and the information included in the drawings is part of this detailed description. The specific embodiments of the invention, which will be described herein, are presented for exemplification purposes, and not for limitation purposes. It should be understood that structural and/or logical modifications could be made by someone of ordinary skills in the art without departing from the scope of the present invention. Therefore, the scope of the present invention is defined only by the accompanying claims and their equivalents.

As used in this disclosure the term QUEUE (or Queue or queue) is defined as a single or a collection of software applications designed to run an advertising method, or parts thereof, according to this invention. Furthermore, the term “mobile device” comprises cell phone, smart phone or any other device, such as a tablet computer, which has the capability of connecting to a mobile network.

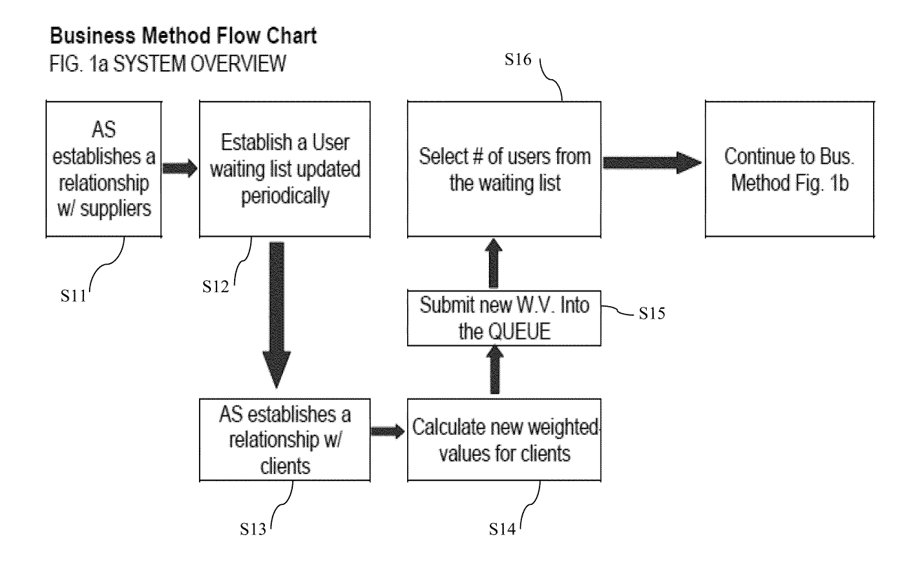

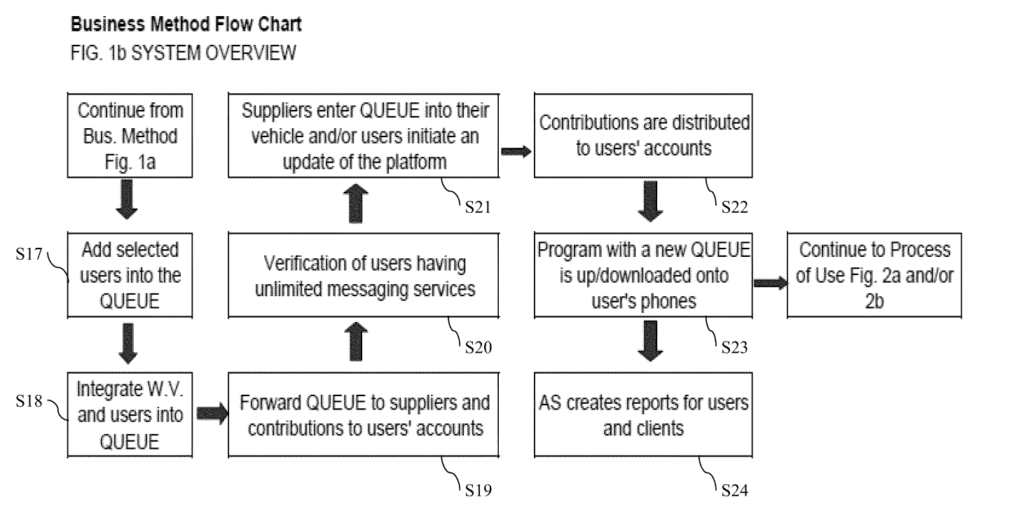

FIG. 1a is a flow chart depicting an overview of an exemplary method of cell phone advertising according to this invention. In step S11, an advertising service (AS) establishes a relationship with suppliers to enable the AS to use the supplier's existing resources, and/or create a system and/or method to display advertisements on the notification window of a text, picture, and/or video message sent and/or received by a user of a mobile device. The supplier may include mobile service providers, mobile device software developers and/or mobile device manufacturers. The mobile device may be a cell phone, a smart phone or the like.

In step S12, the AS creates an user-base of mobile device users that sign up to receive advertisements on their mobile devices via a secured waiting list on a website. In exchange for agreeing to view advertisements, the users may receive an incentive, such as free unlimited messaging, a payment toward their monthly bill or simply a check in the mail. The monetary compensation for the users may be delivered using other methods such as cash, direct deposit, money order, or other cash equivalents.

In one example, the users will have the options to view the advertisers' information, such as address, phone number and other information. The users may supply their zip codes so that advertisements can be provided based on geography and demographics (which is well-known in the art). The user-base may be updated periodically (e.g., hourly) or instantaneously, for example, as a new user signs up. The user-base may be updated to provide a current list of advertisers and their contributions (i.e., for example, dollar amounts they are willing to pay), users and their zip codes, and/or suppliers.

In step S13, AS establishes relationship with its clients, the advertisers. The relationship includes the advertisers specifying the service provider, the service to be sponsored, the geographical location (via, for example, zip codes), demographics (e.g., users age), in relation with which they wish to advertise, and the number of users with whom they wish to advertise. The advertisers may also opt to utilize co-op advertising, which may reduce the advertiser's overall cost. In addition, the advertisers and AS may establish the information the advertiser wishes to have displayed on the user's mobile device. For example, the advertising content, name of advertiser and/or logo.

In step S14, AS establishes a weighted value for its clients (i.e., the advertisers). The weighted value is a ratio between the number of users chosen by the advertiser, considering factors such as, service provider, service to be sponsored, geographical area and/or demographic category and the total number of users who signed up with AS and who have the characteristics desired by the advertiser. Alternatively, the weighted values may be determined by the QUEUE.

In step S15, if established by the AS, the weighted values of the advertisers are submitted to the QUEUE.

In step S16, the number of users specified by the advertiser is selected from the waiting list. There is a master waiting list which includes all the users, from all service providers, who sign up with the AS. An advertiser may choose from this master list a target audience by using selection criteria such as service provider, geographic location and/or demographics. If the master list does not have enough users to meet the advertiser's need (e.g., 100 users), then the advertiser may select additional users using a different selection criteria. For example, if an advertiser would want to target 100 users who are serviced by service provider SP1 in geographical location GL1 and demographics D1, and the master waiting list includes only 80 such users, the advertiser may add 20 users from another service provider SP2 if the users are from the same geographical location GL1 and demographics D1.

In step S17 (FIG. 1b), the selected users are added to the QUEUE for each supplier.

In step S18, the AS integrates the users and the weighted-values into the QUEUE. The suppliers (i.e., service providers) may be able to control this on their end if and after the QUEUE was integrated with their native applications.

In step S19, the AS forwards the QUEUE to suppliers to be inserted for delivery to users. Alternatively, QUEUE can be downloaded by users on their device, and then, the AS can update the QUEUE. The AS also forwards the advertisers' dollar contributions, or part thereof, to suppliers, to the users' accounts with supplier(s) and/or directly to the users.

In step S20, the service provider verifies that users have unlimited messaging service. Working with users who have unlimited messaging service on their mobile device for a flat monthly rate is preferred as it makes the process easier to administer and it gives the advertiser the opportunity for potentially displaying an unlimited number of ads for a flat fee. However, this method of advertising may be applied to other messaging service arrangements, between the users and their providers, such as fixed rate (e.g., $5) for a fixed number of messages (e.g., 200) or fixed rate (e.g., $0.05) per message.

In step S21, the suppliers enter QUEUE into their delivery vehicle, and/or initiate an update of the program. Alternatively, the users download the QUEUE as an application and AS initiates the update.

In step S22, contributions are distributed to users' accounts by suppliers, if in step S19 AS chose to forward them to the suppliers. Alternatively, contributions can be sent by AS (i.e., advertising service) directly to the users.

In step S23, the updated QUEUE, with the new waiting list and weighted values, is up/downloaded into the users' mobile device. This step may occur on a periodic basis, such as monthly or anytime the queue is modified.

In step S24, AS may provide information to the subscribers (i.e., the cell phone users) and/or advertisers (i.e., clients). For example, subscribers may be provided with a list of ads they received; advertisers may receive reports comprising the number of times they were advertised and/or the number of users who saw their ads in a particular zip code or in multiple zip codes.

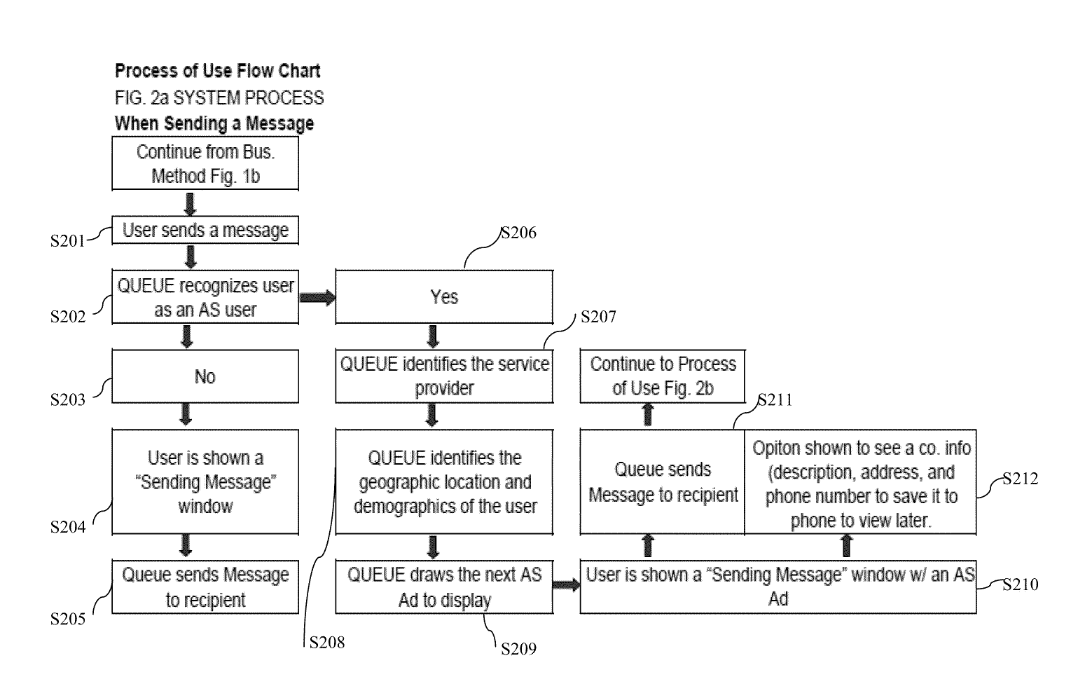

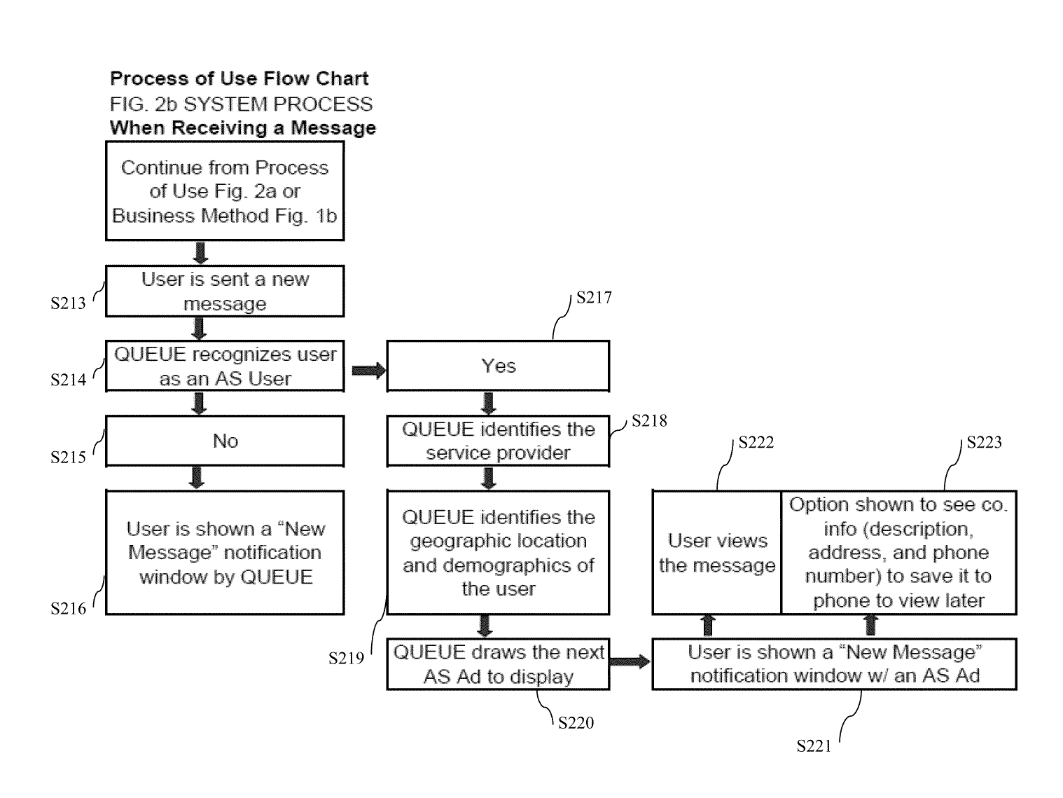

FIG. 2a is a flow chart outlining an exemplary process of cell phone advertising, when a user sends a message, according to this invention. In step S201, a user sends a message to another user. In step S202, QUEUE verifies whether or not the user sending the message is a user registered with the AS, and therefore on the waiting list. If the user sending the message is not S203 a user registered with the AS, he/she sees a “Sending Message” window in step S204, while he/she waits for the message to “leave” his/her phone. In step S205, QUEUE sends message to recipient as normal. Users can use the QUEUE without being registered users on the waiting list. This step is more for verifying that the QUEUE is loaded onto the users' mobile device. When bypassing the suppliers, a user can download the QUEUE and not have signed up on the AS' waiting list. However, when working with the supplier, the QUEUE will become active as a result of the user being on the waiting list. In the latter scenario, a user may not wish to use the QUEUE service even though it could have been pre-installed on their mobile device.

If the user sending the message is S206 a user registered with the AS, then, in step S207, the QUEUE identifies the service provider and, in step S208, the geographic location (i.e., according to zip code) and demographic information of the user sending the message. Next, in step S209, QUEUE draws the next client's (i.e., advertiser's) ad do be displayed according to the weighted-values provided to the supplier or calculated by the QUEUE for that geographic location, demographics and/or supplier. Next, in step S210, the sender sees a “Sending Message” window with an AS ad displayed, while he/she waits for the message to leave his/her phone.

In one example, no further action is needed by the user to terminate this window; it will disappear automatically once the message leaves the phone, they can either view it or not, and, in step S211, QUEUE sends the message to the recipient as normal. Alternatively, while the message leaves the user's phone, he/she may be given the option to view a description of the company being advertised S212. The user may also be given the option to save, for example, the logo of the advertiser, to his/her phone along with the description, address, and phone number for viewing at a later time.

FIG. 2b is a flow chart outlining an exemplary process of cell phone advertising, when a user receives a message, according to this invention. In step S213, the user is sent a new message. In step S214, the QUEUE checks if the recipient is an AS user or not. If the answer is No, S215, then, in step S216, the user is shown a “New Message” (or similar) notification window. If the answer is Yes, S217, then, in step S218, the advertising QUEUE identifies the service provider, and, in step S219, the geographic location and demographic information of the user receiving the message. Next, in step S220, QUEUE draws the next client's ad, according to the weighted-values provided to the supplier.

Next, in step S221, the user is shown a “New Message” window, with an AS ad displayed, until, for example, he/she bypasses the window to view his/her message S222. The ad may or may not have to be displayed for a minimum amount of time before the user can bypass the window. In step S223, while the message leaves the user's phone, he/she may be given the option to view a description of the company being advertised. He/she may also be given the option to save, for example, the logo of the advertiser, to their phone along with the description, address, phone number, etc. for viewing at a later time.

In one example, the advertising QUEUE is the same for both incoming and outgoing messages.

What follows is an example of client weighting: supplier A has 100 total AS users; clients X, Y, and Z contributed for 20, 50, and 30 users, respectively. The weighted-value for each client would then be 0.2, 0.5, and 0.3, respectively. These values reflect the portion of allocated users in the QUEUE each client will receive.

What follows next is an example of the QUEUE's advertising list with weighted-values (using the values from the example above—and based on a scale of 10):

### Clients: Y, Z, Z, X, Y, Y, Y, X, Y, Z.

In another example, if 10 clients/advertisers each select 5 users to advertise with (or sponsor) and the waiting list contains 100 potential users, only the top 50 of those users will be selected while the remaining 50 will not be selected until existing clients advertise with more users or new clients sign up for the service.

It is to be noted that for phones without the notification feature already, creating the service may include building and integrating two programs with each other: one for the QUEUE and one for the notification window. For phones that already have the notification window, i.e. the provider's existing software, the advertising QUEUE may be written to support and/or integrate well with that existing software.

Alternatively, this invention may be practiced by creating a program that can be built into the phone (similar to the calculator or calendar, otherwise know in the art as native applications) and users can “activate” the feature which will trigger the service provider and advertising QUEUE to add that user to the service during the next update. Phones that do not already have this built-in feature may download or have it uploaded onto their phone. Or, the invention may be practiced by creating an application that users may download to their phone either through cross-platform development or a special application developed for various phone types. The periodic update may be used to refresh the list of new advertisers, users, zip codes, contributions, and service providers.

Advertisers may have the option to pay for services other than text messaging service, which are paid through the suppliers (i.e., service providers), such as GPS services, mobile browser, ring-tones, apps, etc. The advertisers may do so through the use of the QUEUE that is integrated with native applications, existing software, etc. or that is installed or pre-installed on mobile devices offered by service providers, handset manufacturers, software (OS) developers, and the like.

It is to be understood that two or more advertisers may pay for the same service of same user, and consequently, the advertisers would, proportionally with their contributions, share the advertising opportunities to that user.

In one example, AS could receive $40 for user #1 that advertiser “A” would like to sponsor. User 41 has a cell phone with a service provider that includes calling, messaging (with integrated QUEUE pre-installed), mobile browser, and one application which the user downloaded that has the QUEUE installed, with recurring monthly charges of $40, $20, $10, and $5 respectively. Since the messaging service contains the QUEUE, and the advertiser chose to advertise on this particular application (i.e., the text messaging), the advertiser is obligated to pay for that portion of the user's recurring monthly charges. In addition, the advertiser in this example has chosen to pay for an additional service that costs the user $5 per month. Therefore, after the services are paid to the user, either directly or through the service provider, the AS retains $15 each month from the payments received from advertiser “A”. The $15 represents in this example the AS' advertising service fee.

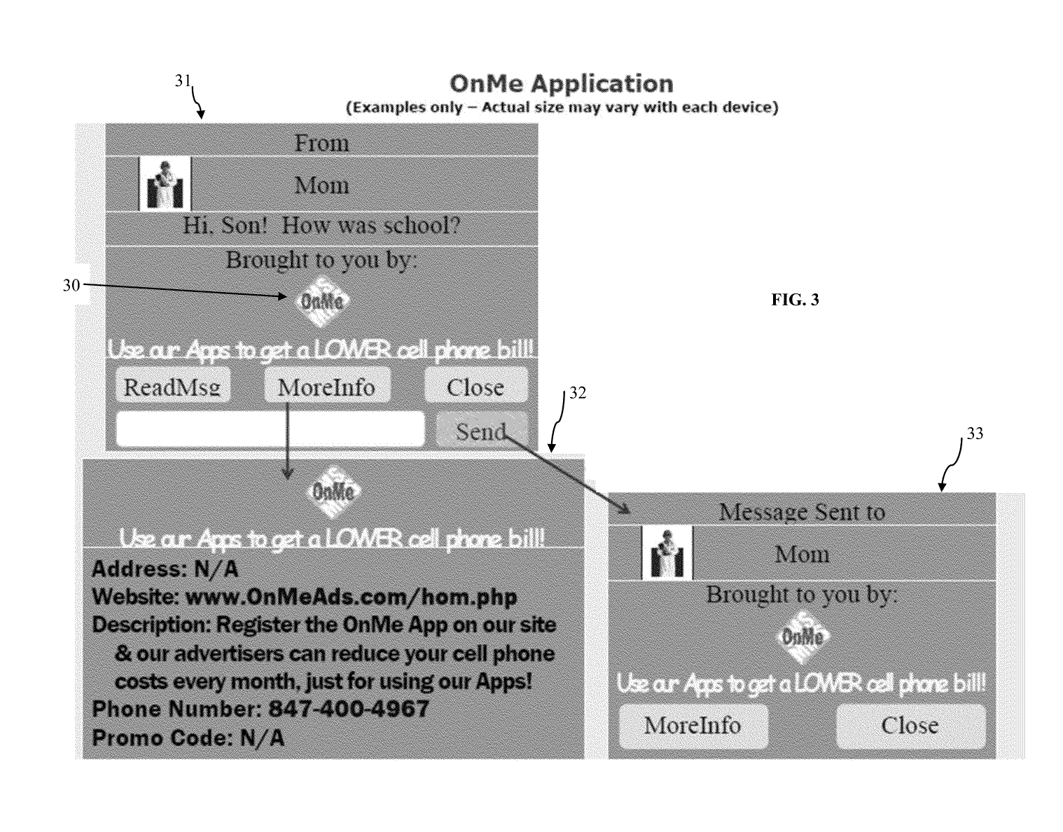

FIG. 3 depicts exemplary cell phone screens with exemplary messages according to this invention. The first screen example 31 is a transformed or modified “New Message” screen produced by QUEUE or by QUEUE's interaction with the native applications and/or software of the mobile device. One modification is the presence of the logo 30 of a sample advertiser, “OnMe”.

Another modification is the presence of a “More Info” button for the user to click on if he/she whishes to find more information about the advertiser. When clicking the “More Info” button, a new screen may be displayed 32, which may include, for example, the name of the advertiser and its contact information such as web address and phone number. The advertiser's logo, its web address or other pieces of its contact information may be hyperlinked to, for example, its website. The advertiser's phone number may be interactive so that the user can place a call to the advertiser by simply clicking on its phone number. Data charges do not apply when clicking on the “More Info” button. The above are only exemplary modifications and they should not be interpreted as limitations of the present invention.

When the user replies, by writing a message to the sender and then clicking the “Send” button, a “Message Sent” screen 33 is displayed, which may also include the logo, the ad of the advertiser or other similar information. The user has the option to send a quick reply from the notification window or through the native messaging application, and the outgoing notification screen 33 would be shown in either case once the user presses the send button. The “Message Sent” screen may be set so that it disappears after a certain amount of time (e.g., 3 seconds). Other screens, such as the actual text message screen, may be similarly modified and/or transformed.

It should be recognized that the advertising method described herein may be used in conjunction with any paid (i.e., non-free) applications on a mobile device, other than text messaging, without departing from the scope of the present invention. Such applications may be GPS service, games, etc. Furthermore, this method may be equally applied to free applications and/or services. In such cases, the users may be compensated by paying for other non-free applications and/or services on their mobile devices and/or by directly sending them monetary rewards (e.g., a check).

Although specific embodiments have been illustrated and described herein for the purpose of disclosing the preferred embodiments, someone of ordinary skills in the art will easily detect alternate embodiments and/or equivalent variations, which may be capable of achieving the same results, and which may be substituted for the specific embodiments illustrated and described herein without departing from the scope of the present invention. Therefore, the scope of this application is intended to cover alternate embodiments and/or equivalent variations of the specific embodiments illustrated and/or described herein. Hence, the scope of the present invention is defined only by the accompanying claims and their equivalents.

What is claimed is:

1. A method of advertising on mobile devices comprising, in any order, the steps of: establishing a user waiting list comprising users who sign up to participate in said method of advertising; determining the weighted values of the advertisers who sign up for the said method of advertising; determining the services which will be sponsored by said advertisers; adding said waiting list, said weighted values and said services to queue; loading said queue into said users' mobile devices; displaying transformed screens, which include the information of at least one of said advertisers, on said users' mobile devices when said users use said services; and, compensating said users for agreeing to participate.

2. A method as in claim 1, wherein said mobile devices comprise cell phones.

3. A method as in claim 1, wherein said services comprise text messaging services.

4. A method as in claim 1, wherein said services are paid for with a flat monthly rate while their use is unlimited.

5. A method as in claim 1, wherein said loading is at least one of the members of the group consisting of downloading initiated by said users, uploading initiated by said mobile devices' service providers, uploading initiated by said mobile devices' manufacturers, uploading initiated by said mobile devices' operating system developers and uploading initiated by the advertising service implementing said method of advertising.

6. A method as in claim 1, wherein said screens are notification screens.

7. A method as in claim 1, wherein said information is at least one member of the group consisting of advertisers' logo, advertisers' name, advertisers' contact information and advertisers' ad.

8. A method as in claim 1, wherein said compensating comprises sending money directly to said users.

9. A method as in claim 1, wherein said compensating comprises sending money to the service providers for said mobile devices to be applied toward said users' bills.

10. A method as in claim 1, further comprising creating reports for said advertisers.

11. A method as in claim 1, further comprising creating reports for the said users.

12. A method of advertising on a mobile device comprising, in any order, the steps of: recognizing that said user signed up for said method of advertising; selecting the sponsoring advertiser whose ad will be displayed on said user's mobile device screen; and, displaying said ad on said user's mobile device screen while said user is employing a sponsored service.

13. A method as in claim 12, further comprising identifying the service provider for said mobile device.

14. A method as in claim 12, further comprising identifying the geographic location and demographic characteristics of said user.

15. A method as in claim 12, wherein said ad is at least one member of the group consisting of advertiser's logo, advertiser's name and advertiser's contact information.

16. A method as in claim 12, wherein said sponsored service is a messaging service.

17. A method as in claim 12, wherein said employing a sponsored service is a member of the group consisting of sending a message and receiving a message.

18. A method as in claim 12, wherein said screen is a notification screen.

19. A method as in claim 17, wherein said message is text message.

20. A method as in claim 12, wherein said selecting comprises considering the weighted value of said advertiser.
